(19) United States
(12) Patent Application Publication
(10) Pub. No.: US 2016/0098473 A1
(43) Pub. Date: Apr. 7, 2016

(54) GROUPING METHOD AND APPARATUS

(71) Applicant: FUJITSU LIMITED, Kawasaki-shi (JP)

(72) Inventors: Shizu Hosokawa, Yokohama (JP); NAOKO SEI, Shizuoka (JP); NOBUO SHIBA, YOKOHAMA (JP)

(21) Appl. No.: 14/841,797

(22) Filed: Sep. 1, 2015

(30) Foreign Application Priority Data
Oct. 3, 2014 (JP) 2014-204777

(51) Int. Cl. G06F 17/30

(52) U.S. Cl. CPC G06F 17/30598; G06F 17/30386

(57) ABSTRACT

A grouping apparatus acquires a plurality of messages output from a plurality of output source apparatuses, respectively. The grouping apparatus acquires a plurality of explanatory texts respectively relating to the plurality of messages, from documents respectively relating to the output source apparatuses. The grouping apparatus generates a plurality of message groups that include related messages respectively, based on the plurality of explanatory texts for the respective messages.

### CROSS-REFERENCE TO RELATED APPLICATION

This application is based upon and claims the benefit of priority of the prior Japanese Patent Application No. 2014-204777, filed on Oct. 3, 2014, the entire contents of which are incorporated herein by reference.

### FIELD

The embodiments discussed herein relate to a grouping method and a grouping apparatus.

### BACKGROUND

For example, an information processing apparatus included in a computer system accumulates, as logs, messages indicating processing execution states. These messages are output from operating systems (OSs), middleware, applications, and the like included in the computer system. The messages indicate processing contents and events such as errors that have occurred. For example, an operator of the information processing apparatus uses such a message accumulated as a log to comprehend an operation status.

Recent computer systems are configured with a plurality of vendor products (various types of devices and software) that operate in coordination with each other. Therefore, when a malfunction occurs in a computer system, an operator of the computer system needs to determine a vendor product that has caused the malfunction from a plurality of vendor products. For example, the operator determines a faulty portion as follows:

[Step 1] Search for logs that are scattered per vendor product and refer to the messages in the logs;
[Step 2] Perform information conversion (interpretation) in consideration of different expressions (synonyms, homonyms, and the like) used in the messages by the vendors and comprehend the meanings of the messages (or the events); and
[Step 3] Repeat the above steps 1 and 2 and determine the event.

However, in the case described above, since the operator needs to perform the operation while referring to the logs and manuals provided by their respective vendors, various problems could arise. For example, the operation could take much time or the operator could make a mistake in judgement (conversion). In addition, the operator could make a mistake in determining the event (or the cause) or a corrective action. In particular, a failure in the system could lead to loss of business opportunities. For this reason, it is extremely important to detect the event promptly and accurately, determine the cause, and restore the system in a short time.

According to a log management technique, log information, which is output from products of a plurality of vendors when malfunctions occur, is collected and sorted, and information indicating the fundamental cause and corrective action per malfunction are generated as a report.

According to another technique, an operator can be presented with only the necessary messages when a malfunction occurs. In this technique, messages generated by a series of malfunctions that are attributed to a single malfunction are associated with each other as messages that belong to one group. When one message is received, provided that the massage is received within a valid period, a predetermined representative message is output.

According to another technique, when various messages are collected from monitoring target calculators, format and text of the messages are converted. Since the messages are converted into messages that can easily be understood by an administrator, time needed for the initial response can be shortened.

See, for example, the following documents: Japanese Laid-open Patent Publication No. 2003-216457; Japanese Laid-open Patent Publication No. 2003-228497; and Japanese Laid-open Patent Publication No. 2008-9475.

When related messages are grouped, if the message text alone is compared, sufficient accuracy could not be obtained. For example, messages output from apparatuses produced by different vendors could have different meanings even if the same words are used. In addition, since a message text represents the content of an event quite simply, it is difficult to accurately comprehend the content only through the message text. Consequently, when messages are grouped by using the conventional techniques, sufficient accuracy in determining related messages is not obtained.

### SUMMARY

According to one aspect, there is provided a non-transitory computer-readable recording medium storing therein a message grouping program that causes a computer to execute a process including: acquiring a plurality of messages that are output from a plurality of output source apparatuses, respectively; acquiring a plurality of explanatory texts from a plurality of documents, the plurality of explanatory texts respectively relating to the plurality of messages, the plurality of documents respectively relating to the plurality of output source apparatuses; and generating a plurality of message groups that include related messages respectively, based on the plurality of explanatory texts for the respective messages.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary functional configuration of a grouping apparatus according to a first embodiment;

FIG. 2 illustrates an exemplary configuration of computer hardware according to a second embodiment;

FIG. 3 is a block diagram illustrating functions of an information processing apparatus;

FIG. 4 illustrates exemplary messages stored in log storage units;

FIG. 5 illustrates exemplary information stored in an output source information storage unit;

FIG. 6 illustrates exemplary detailed message information;

FIG. 7 illustrates an exemplary term master table;

FIG. 8 illustrates an exemplary vendor-unique-term (VUT) master table;

FIG. 9 illustrates an exemplary message information master table;

FIG. 10 is a flowchart illustrating an exemplary procedure for preliminary processing;

FIG. 11 is a flowchart illustrating an exemplary procedure for term master table creation processing;

FIG. 12 is a flowchart illustrating an exemplary procedure for VUT master table creation processing;

FIG. 13 is a flowchart illustrating an exemplary procedure for VUT determination processing;

FIG. 14 illustrates exemplary extraction of vendor-unique terms to be registered in the VUT master table;

FIG. 15 is a flowchart illustrating an exemplary procedure for message information master table creation processing;

FIG. 16 is a flowchart illustrating an exemplary procedure for term and vendor-unique term extraction processing;

FIG. 17 is a flowchart illustrating an exemplary procedure for message grouping processing;

FIG. 18 is exemplary creation of the message information master table;

FIG. 19 is a flowchart illustrating an exemplary procedure for log analysis processing;

FIG. 20 is a flowchart illustrating an exemplary procedure for logged-message grouping processing;

FIG. 21 is a flowchart illustrating an exemplary procedure for message display processing;

FIG. 22 illustrates difference between grouping processing performed by using message texts and grouping processing performed by using explanatory texts; and

FIG. 23 illustrates an example that indicates how accuracy in determining related messages is improved by using vendor-unique terms.

### DESCRIPTION OF EMBODIMENTS

Several embodiments will be described below with reference to the accompanying drawings, wherein like reference numerals refer to like elements throughout. In addition, a plurality of embodiments may be combined and implemented within the scope of consistency.

### First Embodiment

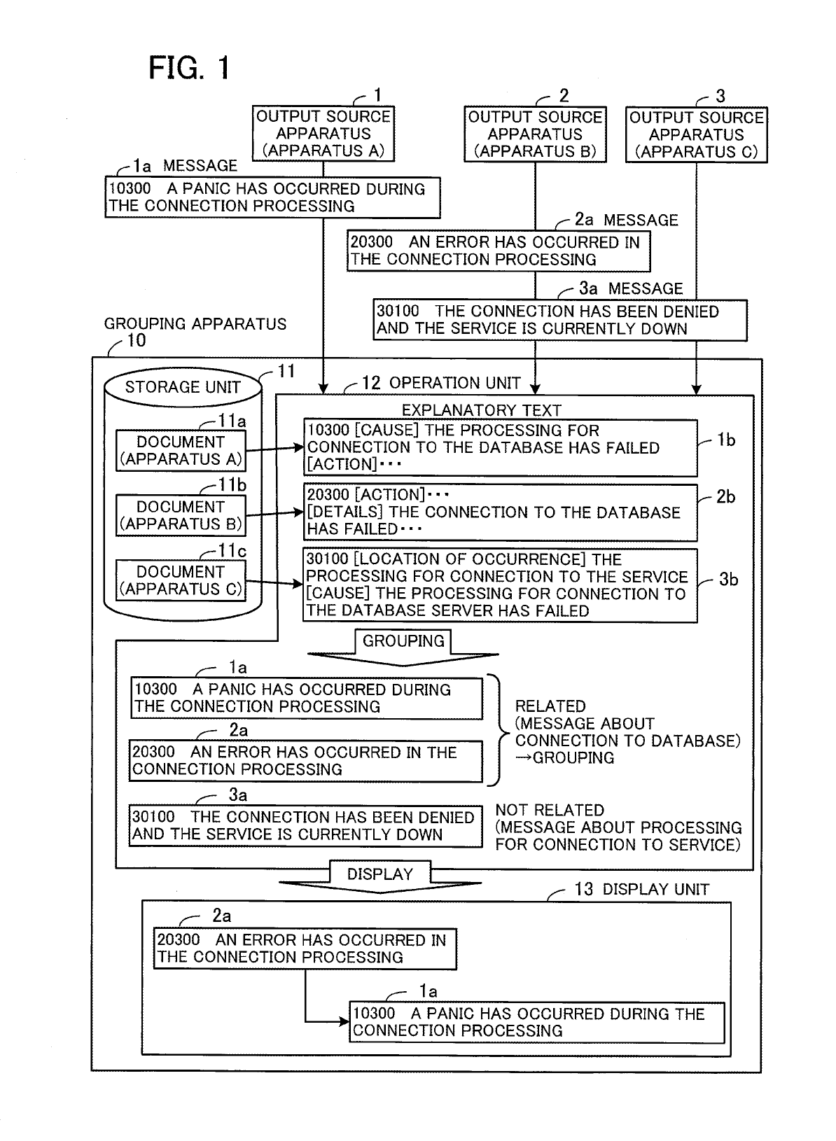

FIG. 1 illustrates an exemplary functional configuration of a grouping apparatus 10 according to a first embodiment. The grouping apparatus 10 according to the first embodiment is connected to a plurality of output source apparatuses 1 to 3. Examples of the output source apparatuses 1 to 3 include: hardware components such as network devices; and virtual machines and applications that operate on computers.

The grouping apparatus 10 includes a storage unit 11 and an operation unit 12 in order to group messages 1a to 3a that are output from the respective output source apparatuses 1 to 3 into groups.

The storage unit 11 holds documents 11a to 11c about the respective output source apparatuses 1 to 3. For example, the documents 11a to 11c are manuals for the respective output source apparatuses 1 to 3.

The operation unit 12 acquires the messages 1a to 3a output from the respective output source apparatuses 1 to 3. In addition, after the output source apparatuses 1 to 3 output the messages 1a to 3a, the operation unit 12 acquires explanatory texts 1b to 3b for the messages 1a to 3a from the documents 11a to 11c, respectively. If the operation unit 12 determines that messages are related to each other on the basis of the explanatory texts 1b to 3b for the respective messages 1a to 3a, the operation unit 12 generates a plurality of message groups each including related messages.

In the grouping processing, for example, the operation unit 12 determines whether messages are related to each other on the basis of the semantic similarity among terms included in the explanatory texts 1b to 3b for the respective messages 1a to 3a. If the operation unit 12 determines that messages are related to each other, the operation unit 12 groups the related messages into the same group.

In addition, in the grouping processing, for example, on the basis of the documents 11a to 11c, from which the respective explanatory texts 1b to 3b are acquired, the operation unit 12 determines whether each of the documents 11a to 11c includes phrases or terms (unique terms) that are unique thereto, and comprehends the meanings of the unique terms. For example, a unique term includes at least one word. In addition, on the basis of the meanings of the unique terms included in the explanatory texts 1b to 3b, the operation unit 12 determines whether one message corresponding to one of the explanatory texts is related to any of the other messages. If messages are related to each other, the operation unit 12 groups the messages into the same group.

For example, the operation unit 12 refers to a document from which an explanatory text is acquired and determines a term that appears in this document and that does not appear in any of the other documents to be a unique term in the document. Next, the operation unit 12 extracts a related term that relates to the meaning of the unique term from information relating to the unique term in the document from which the explanatory text is acquired. The operation unit 12 comprehends the meaning of the unique term used in the document in view of the related term extracted.

According to the grouping apparatus 10, when the output source apparatuses 1 to 3 output the respective messages 1a to 3a, the operation unit 12 acquires the messages 1a to 3a. Next, the operation unit 12 acquires the explanatory texts 1b to 3b for the messages 1a to 3a from the documents 11a to 11c about the output source apparatuses 1 to 3 from which the messages 1a to 3a have been output, respectively. The explanatory texts 1b to 3b include causes, corrective actions, and other detailed information about the messages 1a to 3a, respectively. Next, on the basis of the acquired explanatory texts 1b to 3b, the operation unit 12 determines whether at least two of the messages 1a to 3a are related to each other. In FIG. 1, the explanatory text 1b for the message 1a indicates that the message 1a occurs as a result of a failure of processing for connection to a database, and the explanatory text 2b for the message 2a indicates that the message 2a occurs as a result of a failure of connection to a database. Thus, on the basis of the explanatory texts 1b and 2b, the operation unit 12 determines that both the messages 1b and 2b have occurred as a result of a failure of connection to a database. Therefore, the operation unit 12 determines that the messages 1a and 2a are related to each other.

In contrast, the explanatory text 3b for the message 3a indicates that the message 3a occurs as a result of a failure of processing for connection to a service that connects to a database server. This processing is for connection to an application that accesses a database. Namely, the cause of the message 3a is not due to a failure of connection to a database but due to a failure of connection to a service that accesses a database. Since the cause of the message 3a is not the same as those of the messages 1a and 2a, the operation unit 12 determines that the messages 3a is not related to the message 1a or 2a.

The operation unit 12 is capable of displaying the messages associated in the same group on a screen of a display unit 13 such as a monitor. For example, when the message 2a is selected by a user and is displayed, the message 1a related thereto is also displayed.

Thus, rather than by performing grouping processing on the basis of the message texts, by performing the above grouping processing on the basis of the explanatory texts 1b to 3b, the grouping apparatus 10 groups messages more accurately. For example, the message text of each of the messages 1a to 3a illustrated in FIG. 1 merely indicates occurrence of an error or the like during connection processing. The message texts do not provide any detailed information such as a cause. Namely, if the operation unit 12 performed grouping processing on the basis of the message texts of the messages 1a to 3a alone, all the messages 1a to 3a would be grouped in the same group. However, by referring to the explanatory texts 1b to 3b, the operation unit 12 is able to recognize that the cause of the message 3a is different from those of the other messages 1a and 2a. As a result, the messages 1a and 2a are grouped in the same group, and the message 3a is excluded from the group.

The operation unit 12 may previously determine whether messages are related to each other. In such case, before acquiring the messages 1a to 3a, the operation unit 12 acquires information, which is about a plurality of messages that could be output from the output source apparatuses 1 to 3, from the documents 11a to 11c about the output source apparatuses 1 to 3, respectively. Next, the operation unit 12 acquires explanatory texts for the respective messages that could be output on the basis of the documents about the respective output source apparatuses. Next, on the basis of the explanatory texts for the respective messages that could be output, the operation unit 12 registers the message numbers of the related messages in association with each other. When acquiring the messages 1a to 3a, the operation unit 12 groups, among the plurality of messages, those messages whose message numbers are associated with each other into the same group. By previously determining whether messages are related to each other in this way, the operation unit 12 is able to quickly perform the processing from occurrence of messages to grouping of messages.

The operation unit 12 may be realized by a processor included in the grouping apparatus 10, for example. The storage unit 11 may be realized by a memory included in the grouping apparatus 10, for example.

An individual line connecting elements illustrated in FIG. 1 represents a communication path. Other communication paths than the communication paths in FIG. 1 may be set.

### Second Embodiment

Next, a second embodiment will be described. According to the second embodiment, an information processing apparatus integrally manages messages that are output by processes executing various types of application software programs. This information processing apparatus is an example of the grouping apparatus 10 according to the first embodiment.

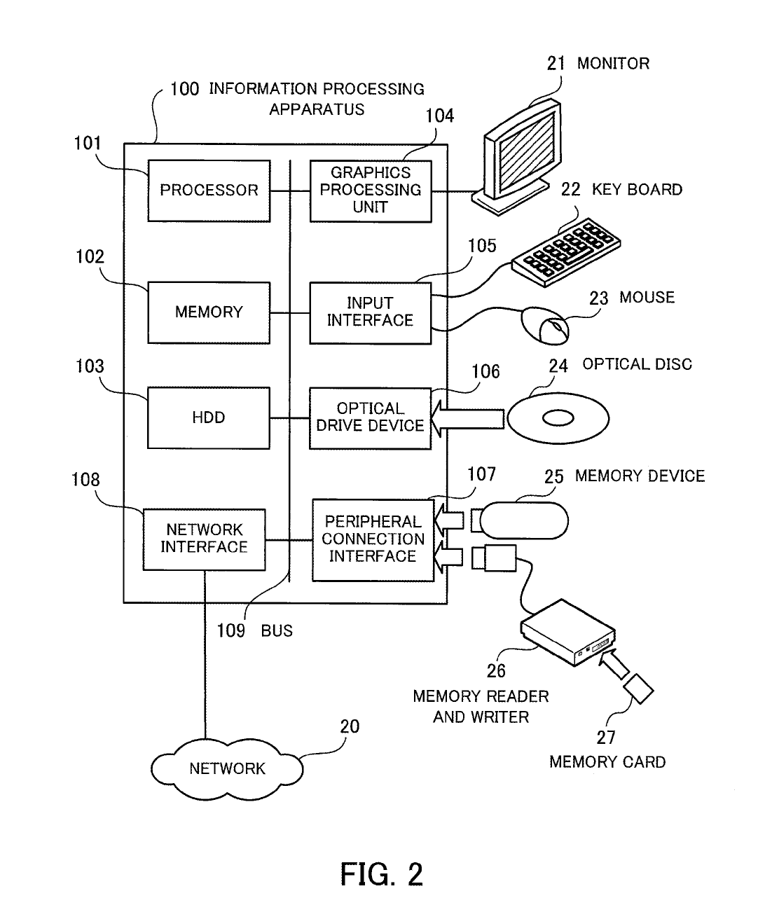

FIG. 2 illustrates an exemplary configuration of computer hardware according to a second embodiment. A processor 101 comprehensively controls an information processing apparatus 100. A memory 102 and a plurality of peripheral devices are connected to the processor 101 via a bus 109. The processor 101 may be a multiprocessor. For example, the processor 101 is a central processing unit (CPU), a micro processing unit (MPU), or a digital signal processor (DSP). An electronic circuit such as an application specific integrated circuit (ASIC) or a programmable logic device (PLD) may be used to realize at least a part of the functions that the processor 101 realizes by executing a program.

The memory 102 is used as a main storage device of the information processing apparatus 100. At least a part of an operating system (OS) program or an application program executed by the processor 101 is temporarily stored in the memory 102. In addition, various types of data needed for processing by the processor 101 are stored in the memory 102. A volatile semiconductor storage device such as a random access memory (RAM) may be used as the memory 102.

Examples of the peripheral devices connected to the bus 109 include a hard disk drive (HDD) 103, a graphics processing unit 104, an input interface 105, an optical drive device 106, a peripheral connection interface 107, and a network interface 108.

The HDD 103 magnetically writes and reads data in and from a disk therein. The HDD 103 is used as an auxiliary storage device of the information processing apparatus 100. OS programs, application programs, and various types of data are stored in the HDD 103. A non-volatile semiconductor storage device such as a flash memory may be used as the auxiliary storage device.

The graphics processing unit 104 is connected to a monitor 21 and displays an image on a screen of the monitor 21 in accordance with a command from the processor 101. For example, a display device using a cathode ray tube (CRT) or a liquid crystal display device may be used as the monitor 21.

The input interface 105 is connected to a keyboard 22 and a mouse 23. The input interface 105 forwards signals transmitted from the keyboard 22 and the mouse 23 to the processor 101. The mouse 23 is an example of a pointing device. Namely, a different pointing device may be used. Examples of such pointing device include a touch panel, a tablet, a touch pad, and a trackball.

The optical drive device 106 uses laser light or the like to read data recorded in an optical disc 24. The optical disc 24 is a portable recording medium in which data readable by optical reflection is recorded. Examples of the optical disc 24 include a digital versatile disc (DVD), a DVD-RAM, a compact disc read only memory (CD-ROM), and a compact disc recordable (CD-R)/rewritable (RW).

The peripheral connection interface 107 is a communication interface for connecting a peripheral device to the information processing apparatus 100. For example, a memory device 25 and a memory reader and writer 26 may be connected to the peripheral connection interface 107. The memory device 25 is a recording medium capable of communicating with the peripheral connection interface 107. The memory reader and writer 26 is a device for writing and reading data in and from a memory card 27. The memory card 27 is a card-type recording medium.

The network interface 108 is connected to a network 20. The network interface 108 exchanges data with other computers or communication devices via the network 20.

The processing functions according to the second embodiment are realized by using the hardware configuration as described above. In addition, the grouping apparatus 10 according to the first embodiment is also realized by using the same hardware configuration as that of the information processing apparatus 100 illustrated in FIG. 2.

For example, the information processing apparatus 100 realizes the processing functions according to the second embodiment by executing a program recorded in a computer-readable recording medium. The program in which the processing contents executed by the information processing apparatus 100 are written may be recorded in various types of recording media. For example, the program executed by the information processing apparatus 100 may be stored in the HDD 103. The processor 101 loads at least a part of the program stored in the HDD 103 onto the memory 102 and executes the program. The program executed by the information processing apparatus 100 may be recorded in a portable recording medium such as the optical disc 24, the memory device 25, or the memory card 27. The program stored in such a portable recording medium is installed to the HDD 103 in accordance with a control operation by the processor 101 or the like, and the processor 101 is allowed to execute the program. The processor 101 may execute the program by reading the program directly from the portable recording medium.

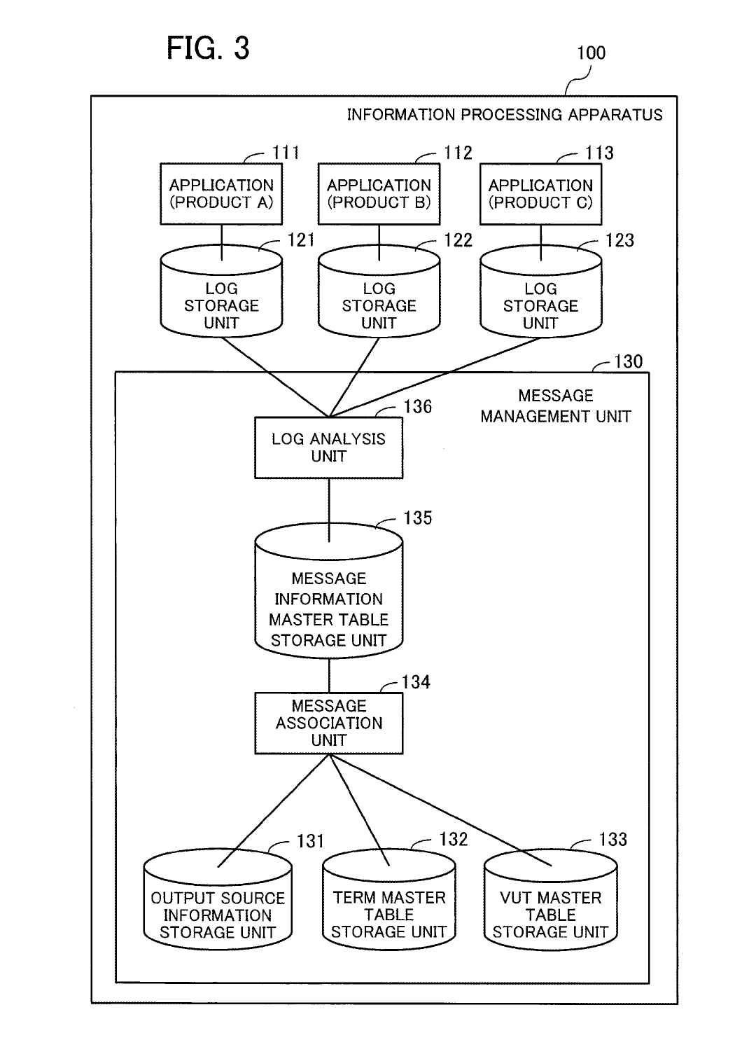

FIG. 3 is a block diagram illustrating functions of the information processing apparatus 100. A plurality of application software programs are installed in the information processing apparatus 100. For example, these application software programs are products produced by different vendors. Hereinafter, processes that execute such application software programs will be referred to as applications 111 to 113.

If a predetermined event occurs during processing, the applications 111 to 113 output messages. For example, if an error occurs, a message indicating the content of the error is output. The messages output from the applications 111 to 113 are stored as logs in log storage units 121 to 123 that correspond to the applications 111 to 113, respectively. The applications 111 to 113 are examples of the output source apparatuses 1 to 3 according to the first embodiment, respectively.

The information processing apparatus 100 further includes a message management unit 130 that manages messages output from the applications 111 to 113. The message management unit 130 includes an output source information storage unit 131, a term master table storage unit 132, a vendor-unique-term (VUT) master table storage unit 133, a message association unit 134, a message information master table storage unit 135, and a log analysis unit 136.

The output source information storage unit 131 holds information about software products corresponding to the respective applications 111 to 113 as output source information. For example, the output source information may be manuals, specifications, or the like, for the software products. For example, a part of the memory 102 or the HDD 103 is used as the output source information storage unit 131.

The term master table storage unit 132 holds a term master table in which terms that could be included in the messages or the explanatory texts for the messages are listed. If terms are semantically similar to each other, these terms are associated with each other and registered in the term master table. For example, a part of the memory 102 or the HDD 103 is used as the term master table storage unit 132.

The VUT master table storage unit 133 holds a VUT master table in which terms unique to an individual vendor are listed as vendor-unique terms. For example, a phrase whose meaning is uniquely defined by a vendor by combining a plurality of words is registered in the VUT master table. If a common word is given a special meaning in output source apparatus information, such word could also be included as a vendor-unique term. For example, a part of the memory 102 or the HDD 103 is used as the VUT master table storage unit 133.

The message association unit 134 generates information (message information entries) about the messages that could be output from the applications 111 to 113. For example, the message association unit 134 groups messages in accordance with relevant message information entries. For example, the message association unit 134 refers to a pair of message or explanatory texts and determines whether the texts share at least a predetermined number of pairs of terms or vendor-unique terms, each pair being semantically the same. If so, the message association unit 134 groups the corresponding messages into the same group. Information about the group to which the massages belong is included in the corresponding message information entry. The message association unit 134 stores the generated message information entries in the message information master table storage unit 135.

The message information master table storage unit 135 holds a message information master table in which the generated message information entries are accumulated. For example, a part of the memory 102 or the HDD 103 is used as the message information master table storage unit 135.

The log analysis unit 136 acquires messages stored in the log storage units 121 to 123 and analyzes the messages. Depending on the analysis result, the log analysis unit 136 groups the messages into a group. In addition, in accordance with an instruction from an operator, the log analysis unit 136 associates the messages that belong to the same group and displays the associated messages on the monitor 21. For example, the log analysis unit 136 displays a message selected by the operator on the monitor 21. In addition, the log analysis unit 136 is able to associate a message that belongs to the same group with the message selected by the operator and display the associated messages on the monitor 21.

An individual line connecting elements illustrated in FIG. 3 represents a communication path. Other communication paths than the communication paths in FIG. 3 may be set. In addition, for example, the functions of each element illustrated in FIG. 3 may be realized by causing a computer to execute a program module corresponding to the element.

Next, exemplary messages stored in the log storage units 121 to 123 will be described.

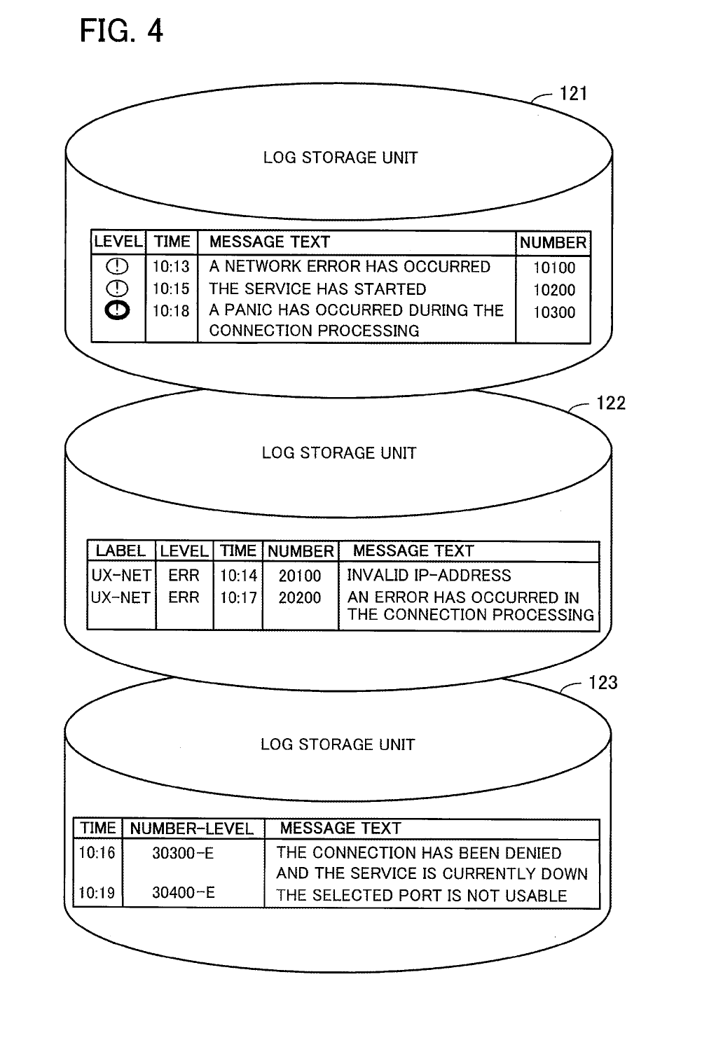

FIG. 4 illustrates exemplary messages stored in the log storage units 121 to 123. Messages output from the application 111 are stored in the log storage unit 121. Each of the messages stored in the log storage unit 121 includes information about a level, time, a message text, and a number (a message identification number), in this order. The level indicates severity of the corresponding error and is represented by a pictogram. In the log storage unit 121 in FIG. 4, the level of a message indicating a particularly severe error is represented by a pictogram with a distinct design.

Messages output from the application 112 are stored in the log storage unit 122. Each of the messages stored in the log storage unit 122 includes information about a label, a level, time, a number, and a message text, in this order. The label indicates additional information such as a name of the application 112.

Messages output from the application 113 are stored in the log storage unit 123. Each of the messages stored in the log storage unit 123 includes information about time, a number-level, and a message text, in this order. As to the number-level, a message identification number is indicated to the left of “-” and a level to the right of “-.”

As described above, the data format of a message that is output varies depending on the application. In addition, there are cases in which two applications use different expressions in their error message texts to indicate the same event. In addition, since message texts are written in brief, messages are insufficiently explained in many cases. To address such problems, according to the second embodiment, the information processing apparatus 100 groups messages by referring to the explanatory texts for the respective messages, the explanatory texts being included in the manuals or the like for the respective applications.

Next, information stored in each of the output source information storage unit 131, the term master table storage unit 132, the VUT master table storage unit 133, and the message information master table storage unit 135 will be described in detail.

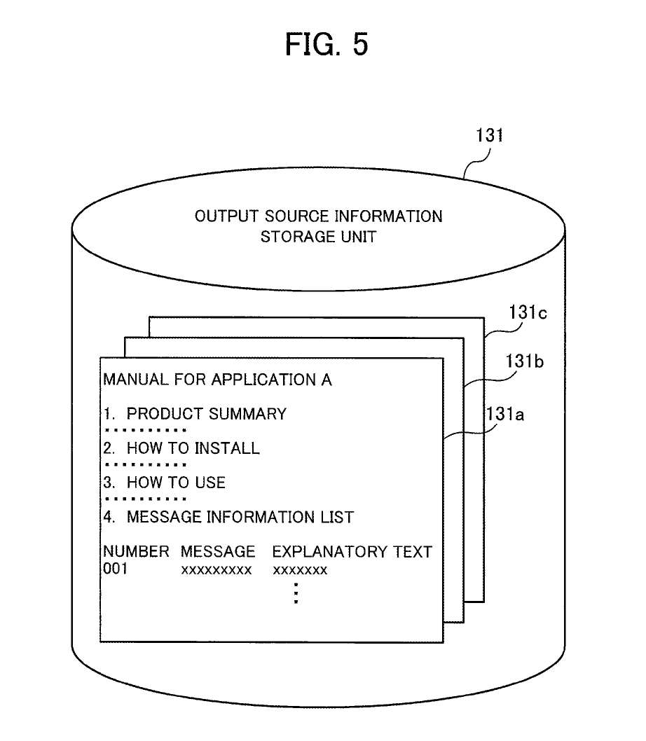

FIG. 5 illustrates exemplary information stored in the output source information storage unit 131. Output source information 131a to 131c about the respective applications 111 to 113 are stored in the output source information storage unit 131. For example, the output source information 131a to 131c are manuals or specifications for the respective applications 111 to 113. The output source information 131a to 131c include various types of technical information about the applications 111 to 113, respectively. For example, the output source information 131a to 131c include a list of information (message information entries) about messages that could be output from the applications 111 to 113, respectively. For example, an entry in such a message information list includes a message information number, a character string included in a message and corresponding to the message information, and an explanatory text for the corresponding message. For example, the explanatory text for the message includes the meaning of the message, a condition under which the message is output, and a corrective action to be taken when the message is output.

Such output source information 131a to 131c are previously prepared and stored in the output source information storage unit 131. The output source information 131a to 131c about the applications 111 to 113 may be stored in a folder (directory) managing files of the applications 111 to 113, respectively. In such case, paths and file names for the output source information 131a to 131c about the applications 111 to 113, respectively, are previously set in the message association unit 134.

The message association unit 134 acquires detailed message information by referring to the output source information storage unit 131.

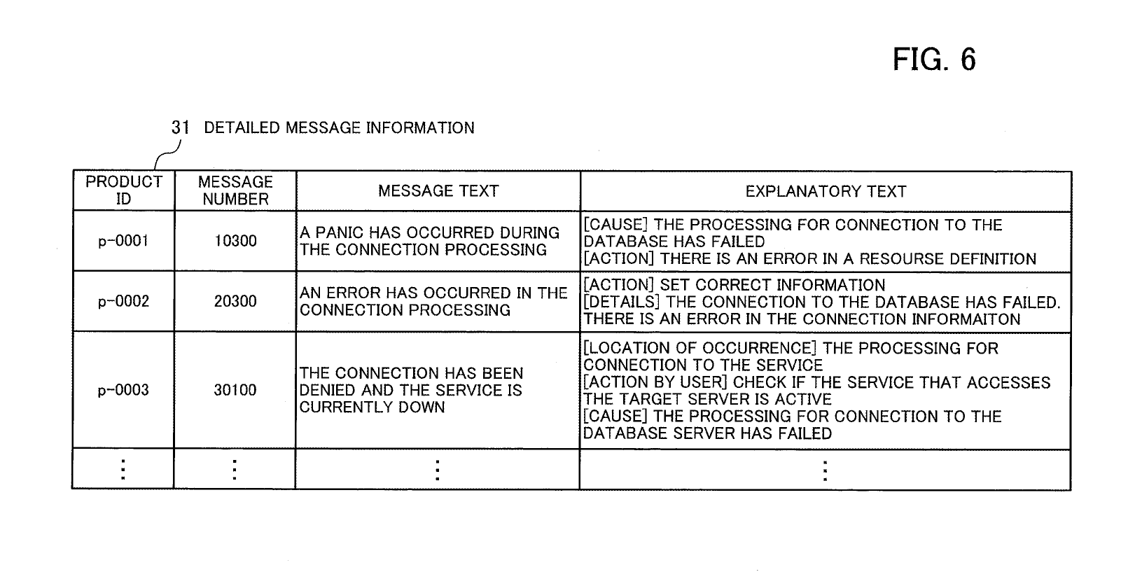

FIG. 6 illustrates exemplary detailed message information. For example, detailed message information 31 includes a product ID, a message number, a message text, and an explanatory text. The product ID is an identifier of the application that has transmitted the corresponding message. The message number is an identification number of the corresponding message that could be output from the corresponding application. The message text is a character string included in the corresponding message. The explanatory text is a text that is included in the corresponding output source information and that explains the corresponding message.

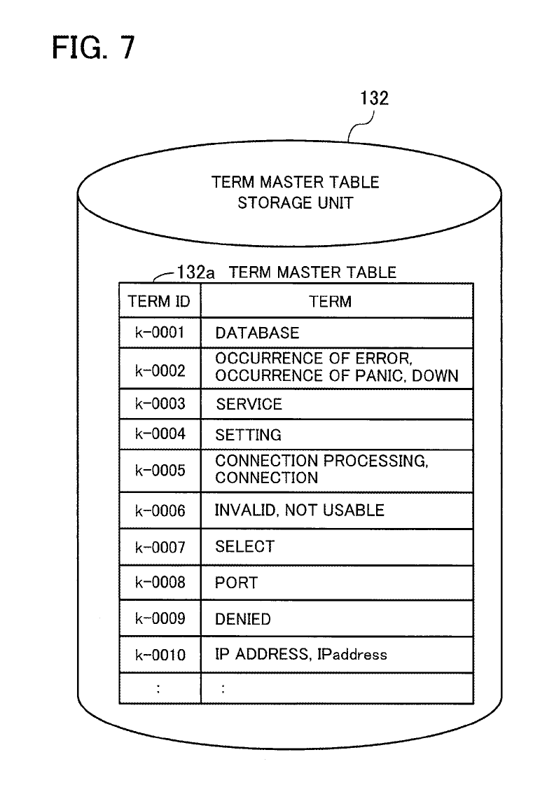

FIG. 7 illustrates an exemplary term master table. A term master table 132a is stored in the term master table storage unit 132. For example, at least one term is registered in the term master table 132a, and each of the registered terms is associated with a term ID. For example, a plurality of terms that are synonymous with each other are associated with the same term ID and registered in the master table 132a.

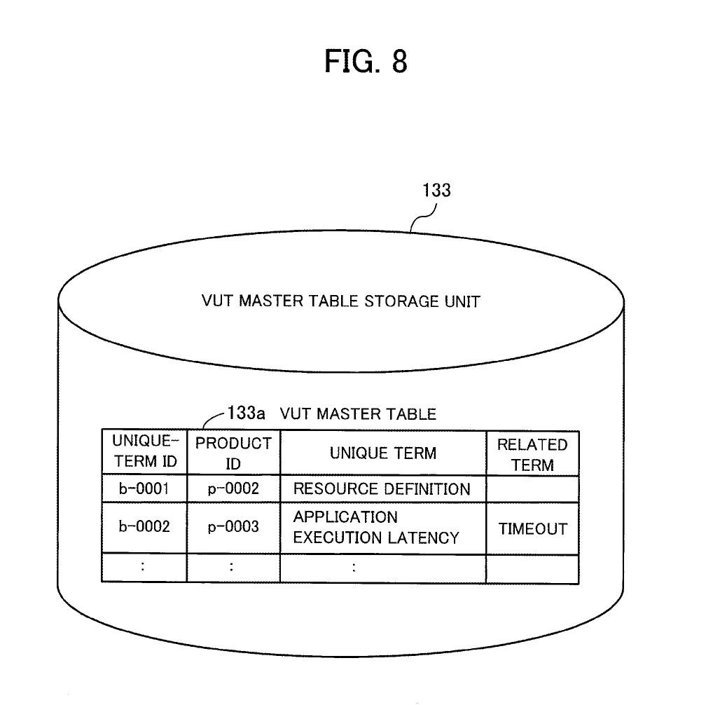

FIG. 8 illustrates an exemplary VUT master table. A VUT master table 133a is stored in the VUT master table storage unit 133. For example, the VUT master table 133a includes columns for UNIQUE-TERM ID, PRODUCT ID, UNIQUE TERM, and RELATED TERM. An entry in the VUT master table 133a will be described. In a box under UNIQUE-TERM ID, identification information about the corresponding vendor-unique term (a unique-term ID) is registered. In a box under PRODUCT ID, identification information (a product ID) about an application that corresponds to the output source information from which the corresponding vendor-unique term is extracted is registered. In a box under UNIQUE TERM, the corresponding vendor-unique term extracted is registered. In a box under RELATED TERM, if any, a related term that relates to the corresponding vendor-unique term is registered. For example, such a related term is a term that is included in a definition sentence of the vendor-unique term in the corresponding output source information.

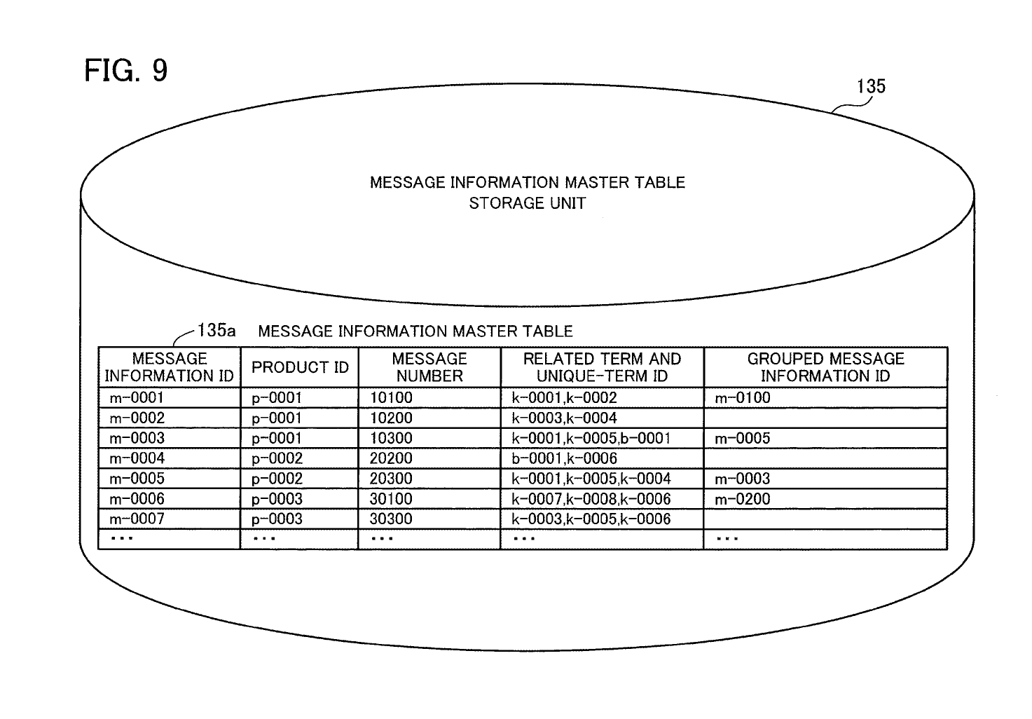

FIG. 9 illustrates an exemplary message information master table. A message information master table 135a is stored in the message information master table storage unit 135. The message information master table 135a includes columns for MASSAGE INFORMATION ID, PRODUCT ID, MESSAGE NUMBER, RELATED TERM AND UNIQUE-TERM ID, and GROUPED MESSAGE INFORMATION ID.

An entry in the message information master table 135a will be described. In a box under MESSAGE INFORMATION ID, an identifier (a message information ID) used for identifying message information in the message management unit 130 is registered. In a box under PRODUCT ID, a product ID of an application that corresponds to the output source information from which the corresponding message information is extracted is registered. In a box under MESSAGE NUMBER, an identification number (a message number) of a message indicated in the message information is registered. The message number is assigned to the message by the corresponding application when the application outputs the message.

In a box under the column RELATED TERM AND UNIQUE-TERM ID, among the terms or the vendor-unique terms included in the message corresponding to the message information ID or in the explanatory text for the message, a term ID of a term registered in the term master table 132a or a unique term ID of a vendor-unique term registered in the VUT master table 133a is registered. In addition, in the box under RELATED TERM AND UNIQUE-TERM ID, a term ID of a term (a related term) that relates to a vendor-unique term included in the message corresponding to the message information ID or in the explanatory text for the message is also registered.

In a box under GROUPED MESSAGE INFORMATION ID, if any, a message information ID of other message information that belongs to the same group with this message information is registered. The grouped messages are indicated by the information registered in the box under GROUPED MESSAGE INFORMATION ID. Namely, if information in the box under GROUPED MESSAGE INFORMATION ID corresponding to a certain message information ID includes another message information ID, the messages indicated by these message information IDs belong to the same group.

Next, preliminary processing for creating the term master table, the VUT master table, and the message information master table will be described.

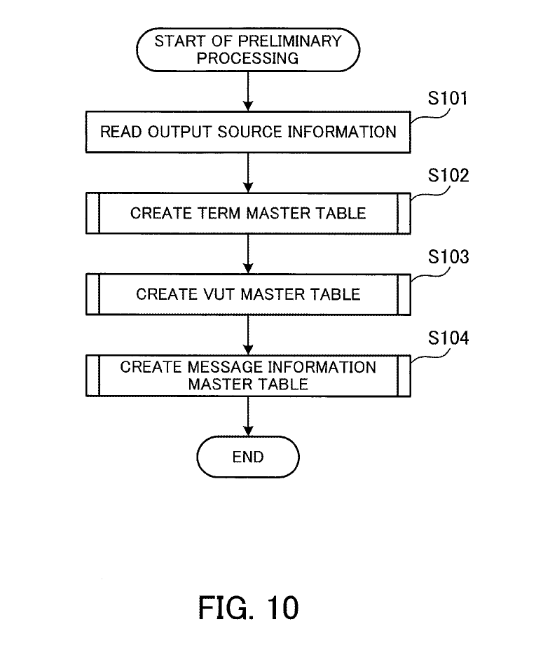

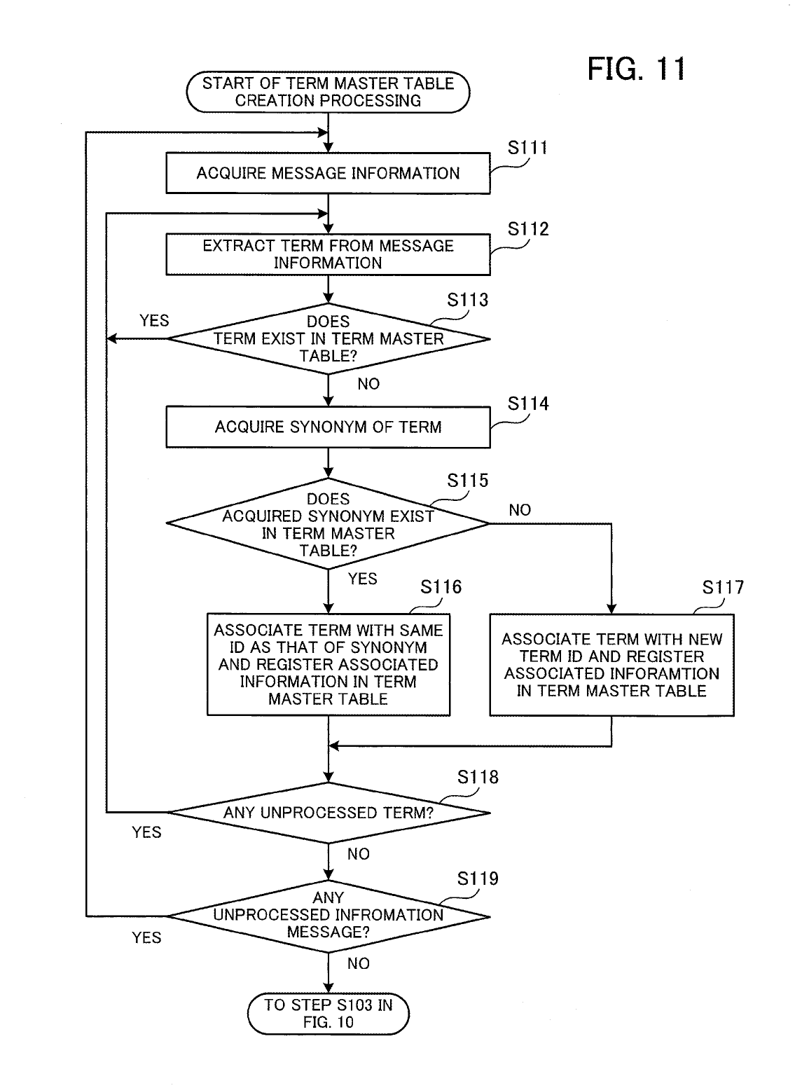

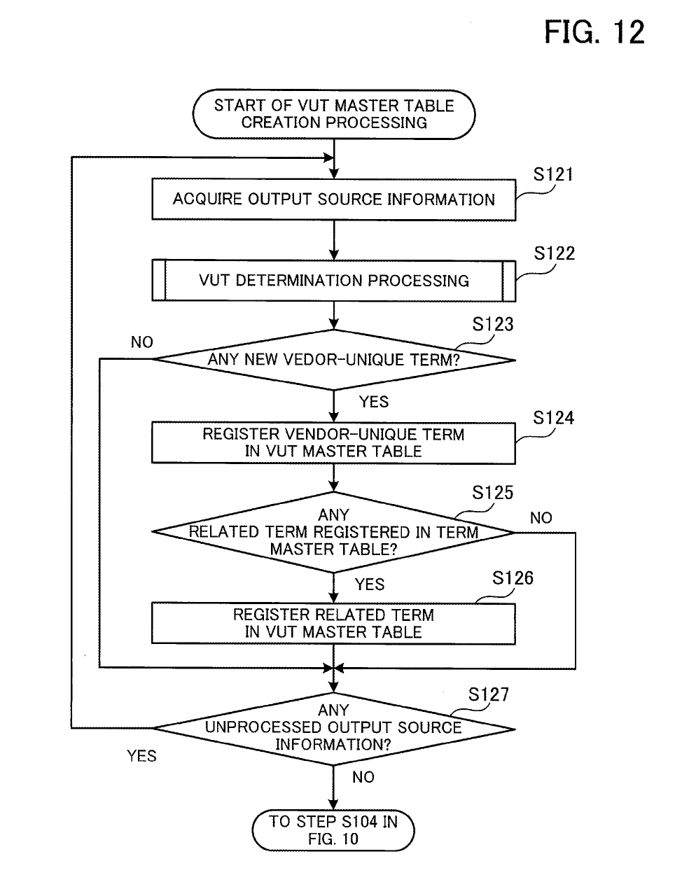

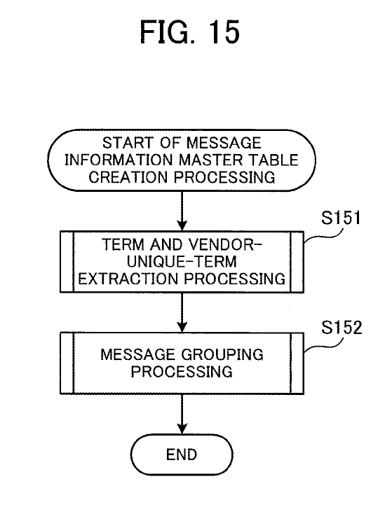

FIG. 10 is a flowchart illustrating an exemplary procedure for preliminary processing.

[Step S101] The message association unit 134 reads the output source information 131a to 131c from the output source information storage unit 131.

[Step S102] The message association unit 134 creates the term master table 132a. The message association unit 134 stores the created term master table 132a in the term master table storage unit 132. Processing for creating the term master table will be described in detail below with reference to FIG. 11.

[Step S103] The message association unit 134 creates the VUT master table 133a. The message association unit 134 stores the created VUT master table 133a in the VUT master table storage unit 133. Processing for creating the VUT master table will be described in detail below with reference to FIG. 12.

[Step S104] The message association unit 134 creates the message information master table 135a. The message association unit 134 stores the created message information master table 135a in the message information master table storage unit 135. Processing for creating the message information master table will be described in detail below with reference to FIG. 15.

Next, a procedure for the term master table creation processing will be described in detail.

FIG. 11 is a flowchart illustrating an exemplary procedure for creating the term master table 132a.

[Step S111] The message association unit 134 acquires message information that has not been processed yet, among the message information included in the output source information 131a to 131c. For example, the message association unit 134 analyzes the output source information 131a to 131c and finds message information lists included in the respective output source information 131a to 131c. Next, from the message information lists included in the respective output source information 131a to 131c, the message association unit 134 sequentially acquires message information.

[Step S112] The message association unit 134 extracts a term from the message in the acquired message information or from the explanatory text for the message. For example, the message association unit 134 extracts a term by performing a morphological analysis on a character string included in the message (message text) in the message information and the explanatory text for the message.

[Step S113] The message association unit 134 determines whether the extracted term exists in the term master table 132a stored in the term master table storage unit 132. If the extracted term does not exist in the term master table 132a, the processing proceeds to step S114. If the extracted term exists in the term master table 132a, the processing returns to step S112 in which the message association unit 134 extracts another term.

[Step S114] The message association unit 134 acquires a synonym of the term. The message association unit 134 may acquire a synonym of the term from a dictionary of synonyms available through the Internet, for example. A dictionary of synonyms may be previously stored in the HDD 103 of the information processing apparatus 100, and the message association unit 134 may acquire a synonym from this dictionary stored in the HDD 103. The message association unit 134 may change the range of similarity by referring to a relationship among a plurality of terms. For example, in a common dictionary of synonyms, “loss” is not listed as a synonym of “drop.” However, “drop of a message” and “loss of a message” have a similar meaning. Therefore, for example, if “drop” is followed by “of a message,” the message association unit 134 determines that “drop” is a synonym of “loss.”

[Step S115] The message association unit 134 determines whether the synonym of the extracted term exists in the term master table 132a. If the synonym exists in the term master table 132a, the processing proceeds to step S116. If not, the processing proceeds to step S117.

[Step S116] The message association unit 134 associates the extracted term with the same term ID as that of the synonym and registers the associated information in the term master table 132a. Next, the processing proceeds to step S118.

[Step S117] The message association unit 134 associates the extracted term with a new term ID and registers the associated information in the term master table 132a.

[Step S118] The message association unit 134 determines whether the acquired message information includes another term that has not been processed yet. If so, the processing returns to step S112, and the message association unit 134 extracts the unprocessed term. If all the terms included in the acquired message information have been processed, the processing proceeds to step S119.

[Step S119] The message association unit 134 determines whether any other message information that has not been processed yet exists. If so, the processing returns to step S111 in which the message association unit 134 acquires the unprocessed message information. If all the message information has been processed, the message association unit 134 ends the term master table creation processing.

In this way, the message association unit 134 creates the term master table 132a. The message association unit 134 creates the VUT master table 133a by using the created term master table 132a.

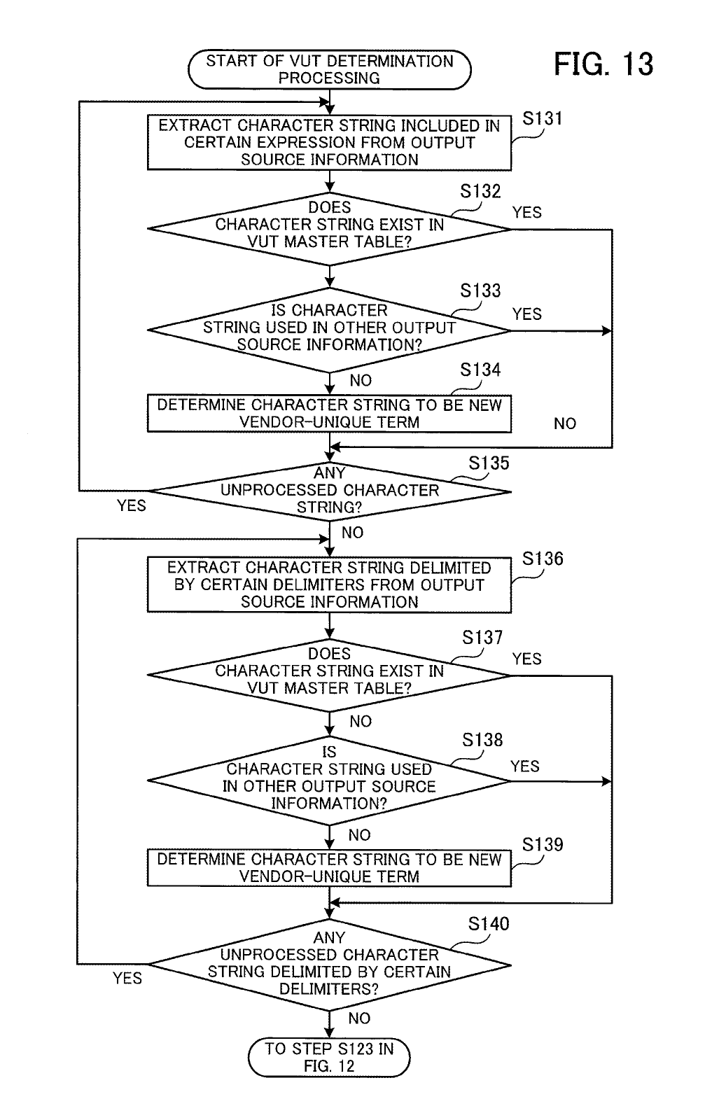

FIG. 12 is a flowchart illustrating an exemplary procedure for creating the VUT master table 133a.

[Step S121] The message association unit 134 acquires output source information that has not been processed yet from the output source information storage unit 131.

[Step S122] The message association unit 134 performs VUT determination processing in which a vendor-unique term included in the output source information is detected. The VUT term determination processing will be described in detail below with reference to FIG. 13.

[Step S123] The message association unit 134 determines whether a new vendor-unique term has been extracted. If a new vendor-unique term has been extracted, the processing proceeds to step S124. If not, the processing proceeds to step S127.

[Step S124] The message association unit 134 associates the extracted vendor-unique term with a new unique-term ID and registers the associated information in the VUT master table 133a.

[Step S125] The message association unit 134 determines whether a term (related term) that relates to the extracted vendor-unique term is registered in the term master table 132a. For example, the message association unit 134 determines a term, which is other than the vendor-unique term and which is included in an explanation sentence that explains the vendor-unique term, to be a related term. If there is a sentence that begins with “XX means,” a term included in the sentence following “means” is determined to be a related term. If there is such a related term, the processing proceeds to step S126. If not, the processing proceeds to step S127.

[Step S126] The message association unit 134 registers the related term in the VUT master table 133a as a related term that relates to the extracted vendor-unique term.

[Step S127] The message association unit 134 determines whether there is any other output source information that has not been processed yet. If there is such unprocessed output source information, the processing returns to step S121. In step S121, the message association unit 134 acquires the output source information. If all the output source information has been processed, the message association unit 134 ends the VUT master table creation processing.

Next, the VUT determination processing will be described in detail.

FIG. 13 is a flowchart illustrating an exemplary procedure for determining vendor-unique terms.

[Step S131] The message association unit 134 extracts a character string included in a certain expression from the output source information acquired in step S121. For example, the message association unit 134 detects a certain expression pattern including “means” or “is defined as.” Next, the message association unit 134 extracts a term immediately before “means” or “is defined as.” For example, if an expression begins with “AA means,” the message association unit 134 extracts the character string “AA.”

[Step S132] The message association unit 134 determines whether the character string extracted in step S131 exists in the VUT master table 133a. If the character string exists in the VUT master table 133a, the processing proceeds to step S135. If not, the processing proceeds to step S133.

[Step S133] The message association unit 134 determines whether the character string extracted in step S131 is used in any other output source information. For example, the message association unit 134 searches all the output source information other than the output source information from which this character string is extracted for the extracted character string. If any of the other output source information includes such character string, the message association unit 134 determines that the character string is used in the output source information, and the processing proceeds to step S135. If the extracted character string is not found in any of the other output source information, the message association unit 134 determines that the character string is not used in the other output source information, and the processing proceeds to step S134.

[Step S134] If the character string extracted in step S131 is neither registered in the VUT master table 133a nor used in the other output source information, the message association unit 134 determines that the character string is a new vendor-unique term.

[Step S135] The message association unit 134 determines whether there is any other character string that is included in the certain expression and that has not been extracted yet, in the output source information acquired in step S121. If there is such character string, the processing returns to step S131. If not, the message association unit 134 ends the VUT extraction processing based on a certain expression. Next, the processing proceeds to step S136.

[Step S136] The message association unit 134 extracts a character string delimited by certain delimiters from the output source information. For example, the message association unit 134 extracts a character string delimited by delimiters such as parentheses, brackets, double quotation marks, spaces, and tabs.

[Step S137] The message association unit 134 determines whether the character string extracted in step S136 exists in the VUT master table 133a. If the extracted character string exists in the VUT master table 133a, the processing proceeds to step S140. If not, the processing proceeds to step S138.

[Step S138] The message association unit 134 determines whether the character string extracted in step S136 is used in the other output source information. For example, the message association unit 134 searches all the output source information other than the output source information from which the character string extracted for the extracted character string. If any of the other output source information includes such character string, the message association unit 134 determines that the character string is used in the output source information, and the processing proceeds to step S140. If the extracted character string is not found in any of the other output source information, the message association unit 134 determines that the character string is not used in the other output source information, and the processing proceeds to step S139.

[Step S139] Since the character string extracted in step S136 is neither registered in the VUT master table 133a nor used in the other output source information, the message association unit 134 determines that the character string is a new vendor-unique term.

[Step S140] The message association unit 134 determines whether there is any other character string that is delimited by the certain delimiters and that has not yet been extracted in the output source information acquired in step S136. If there is such character string, the processing returns to step S136. If not, the message association unit 134 ends the VUT determination processing.

The message association unit 134 creates the VUT master table 133a by performing the processing described with reference to FIGS. 12 and 13.

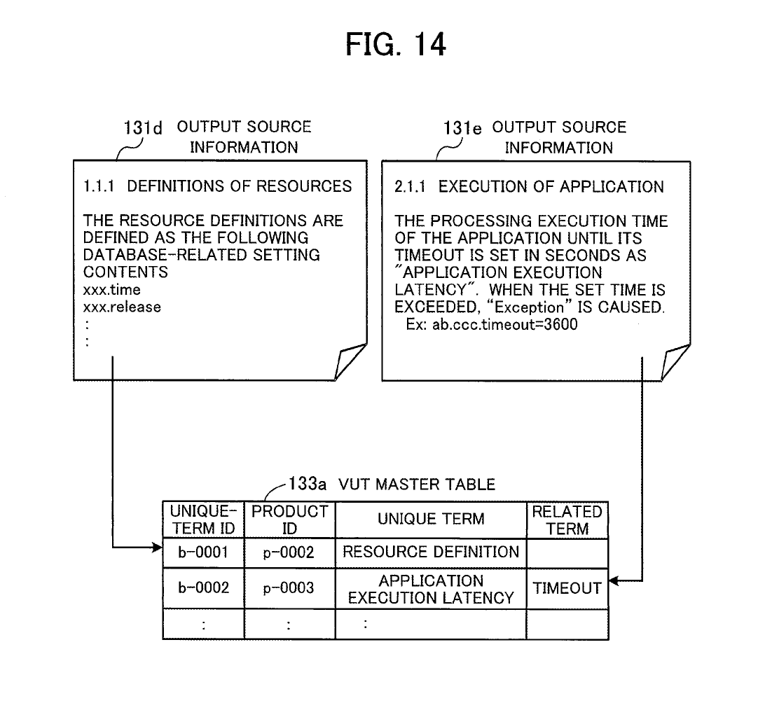

FIG. 14 illustrates exemplary extraction of vendor-unique terms that are registered in the VUT master table 133a. For example, output source information 131d includes a sentence “The resource definitions are defined as the following database-related setting contents.” The message association unit 134 determines that the expression “the resource definitions are defined as” in this sentence is the certain expression and extracts the character string “resource definition” as a vendor-unique term from this expression.

In addition, output source information 131e includes a sentence “The processing execution time of the application until its timeout is set in seconds as “application execution latency”.” The message association unit 134 extracts, as a vendor-unique term, the character string “application execution latency” delimited by double-quotation marks, which are the certain delimiters. In addition, “timeout” in this sentence is extracted as a related term associated with “application execution latency.”

Having created the term master table 132a and the VUT master table 133a, the message association unit 134 creates the message information master table 135a on the basis of the term master table 132a and the VUT master table 133a.

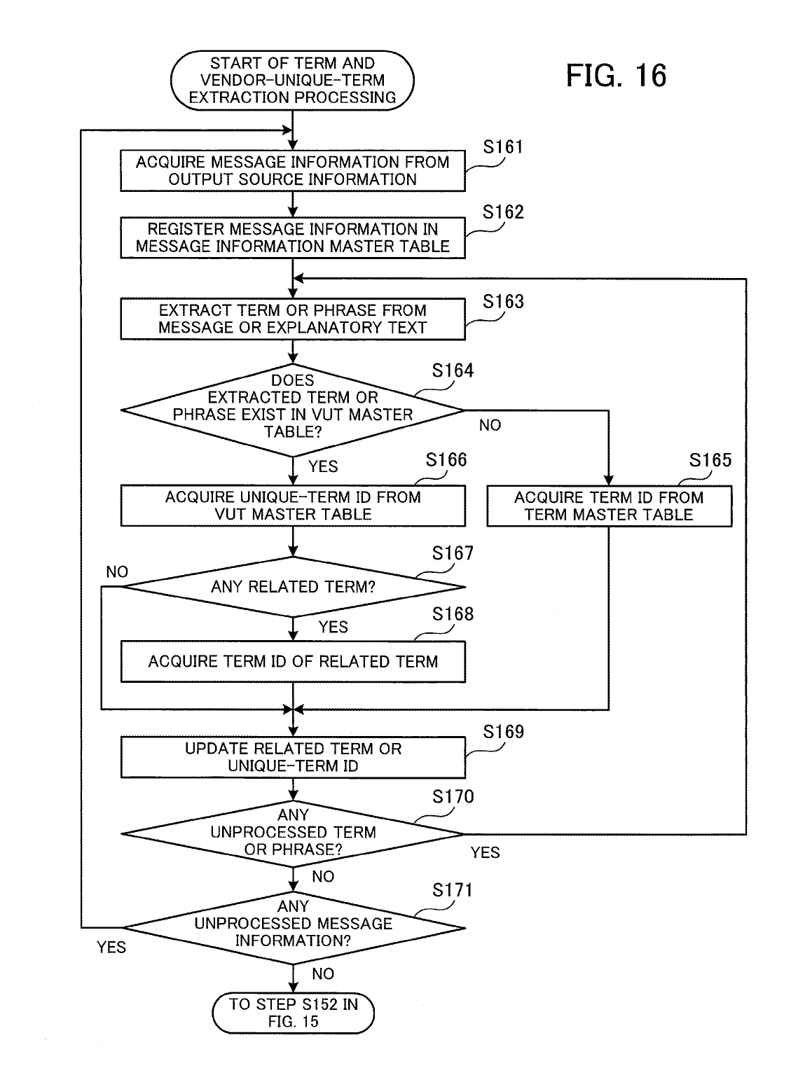

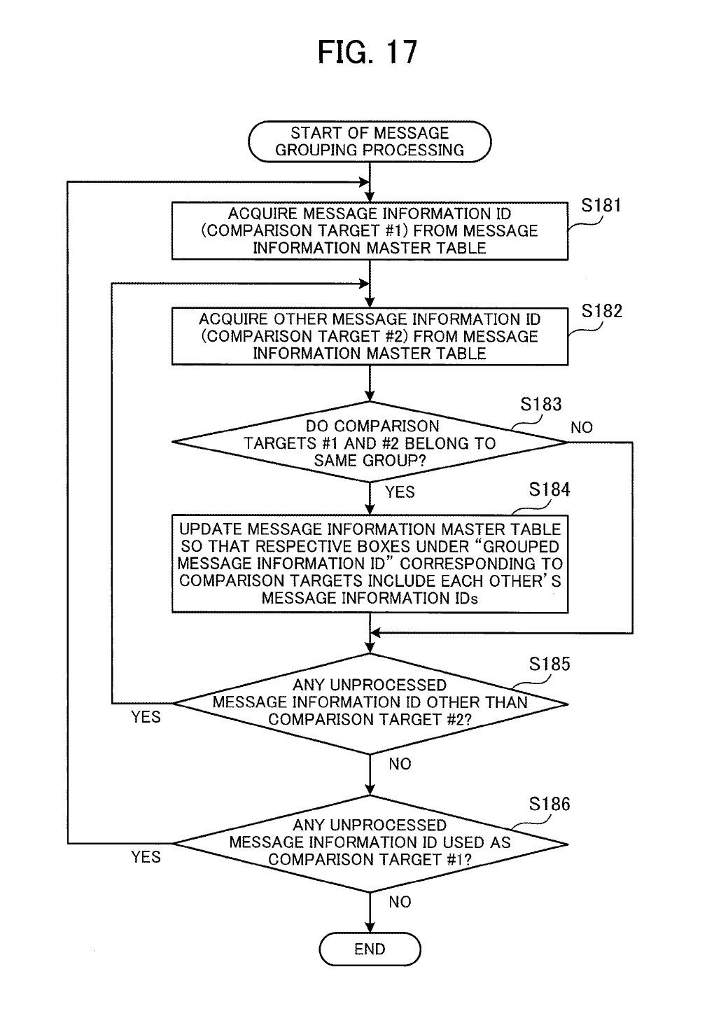

FIG. 15 is a flowchart illustrating an exemplary procedure for creating the message information master table.

[Step S151] The message association unit 134 performs processing for extracting terms and vendor-unique terms from messages. This processing will be described in detail below with reference to FIG. 16.

[Step S152] The message association unit 134 performs processing for grouping messages. This processing will be described in detail below with reference to FIG. 17.

Next, a procedure for the processing for extracting terms and vendor-unique terms will be described in detail.

FIG. 16 is a flowchart illustrating an exemplary procedure for the processing for extracting terms and vendor-unique terms.

[Step S161] The message association unit 134 acquires message information that has not been processed yet from the output source information 131a, 131b, or 131c.

[Step S162] The message association unit 134 registers the acquired message information in the message information master table 135a. For example, the message association unit 134 associates a product ID of the product that corresponds to the output source information from which the message information has been extracted and a message number of the message information with a new message information ID. The message association unit 134 registers the associated information in the message information master table 135a.

[Step S163] The message association unit 134 extracts a term or phrase from the message text or the corresponding explanatory text included in the acquired message information.

[Step S164] The message association unit 134 determines whether the extracted term or phrase exists in the VUT master table 133a. If the extracted term or phrase exists in the VUT master table 133a, the processing proceeds to step S166. If not, the processing proceeds to step S165.

[Step S165] The message association unit 134 acquires the term ID of the extracted term or phrase from the term master table 132a, and the processing proceeds to step S169.

[Step S166] The message association unit 134 acquires the unique-term ID of the extracted term or phrase from the VUT master table 133a.

[Step S167] The message association unit 134 determines whether there is any related term associated with the extracted term or phrase in the VUT master table 133a. If there is a related term associated with the extracted term or phrase, the processing proceeds to step S168. If not, the processing proceeds to step S169.

[Step S168] The message association unit 134 acquires the term ID of the related term that is associated with the extracted term or phrase and registered in the VUT master table 133a.

[Step S169] The message association unit 134 updates the term or unique-term ID about the message information acquired in step S161 in the message information master table 135a. For example, the message association unit 134 associates the term ID acquired in step S165 or the term ID of the related term acquired in step S168 with the message information ID of the message information acquired in step S161 and registers the associated information in the column RELATED TERM AND UNIQUE-TERM ID.

[Step S170] The message association unit 134 determines whether there is any unprocessed term or phrase in the message text or the corresponding explanatory text in the acquired message information. If there is an unprocessed term or phrase, the processing returns to step S163. If not, the processing proceeds to step S171.

[Step S171] The message association unit 134 determines whether there is any unprocessed message information. If there is such message information, the processing returns to step S161. If not, the message association unit 134 ends the term and vendor-unique term extraction processing.

Next, the message grouping processing will be described.

FIG. 17 illustrates an exemplary procedure for the message grouping processing.

[Step S181] The message association unit 134 acquires an unprocessed message information ID from the message information master table 135a. The message association unit 134 uses the acquired message information ID as a comparison target #1.

[Step S182] The message association unit 134 acquires another message information ID other than the comparison target #1 from the message information master table 135a. The message association unit 134 uses the acquired message information ID as a comparison target #2.

[Step S183] The message association unit 134 determines whether the comparison target #1 and the comparison target #2 belong to the same group. For example, the message association unit 134 compares the term IDs or unique-term IDs registered in the column RELATED TERM AND UNIQUE-TERM ID corresponding to the respective comparison targets #1 and #2. If at least a predetermined number of term IDs or unique-term IDs are shared, the message association unit 134 determines that the comparison targets #1 and #2 belong to the same group.

If the comparison targets #1 and #2 belong to the same group, the processing proceeds to step S184. If not, the processing proceeds to step S185.

[Step S184] The message association unit 134 updates the message information master table 135a so that the respective boxes under GROUPED MESSAGE INFORMATION ID corresponding to the comparison targets #1 and #2 include each other's message information IDs.

[Step S185] The message association unit 134 determines whether there is any message information ID that is other than comparison target #2 and on which the processing described in step S182 to S184 has not been performed yet. If there is such message information ID, the processing returns to step S182. If not, the processing proceeds to step S186.

[Step S186] The message association unit 134 determines whether there is any message information ID on which the processing described in step S181 to S185 has not been performed yet (namely, a message information ID that has not been used yet as the comparison target #1). If there is such message information ID, the processing returns to step S181. If not, the message association unit 134 ends the message grouping processing.

In this way, by using not only the semantic similarity among terms or vendor-unique terms in message texts but also the semantic similarity among terms in the explanatory texts for the message texts, the message association unit 134 groups messages. The message association unit 134 creates the message information master table 135a by setting the result of the grouping in the message information master table 135a.

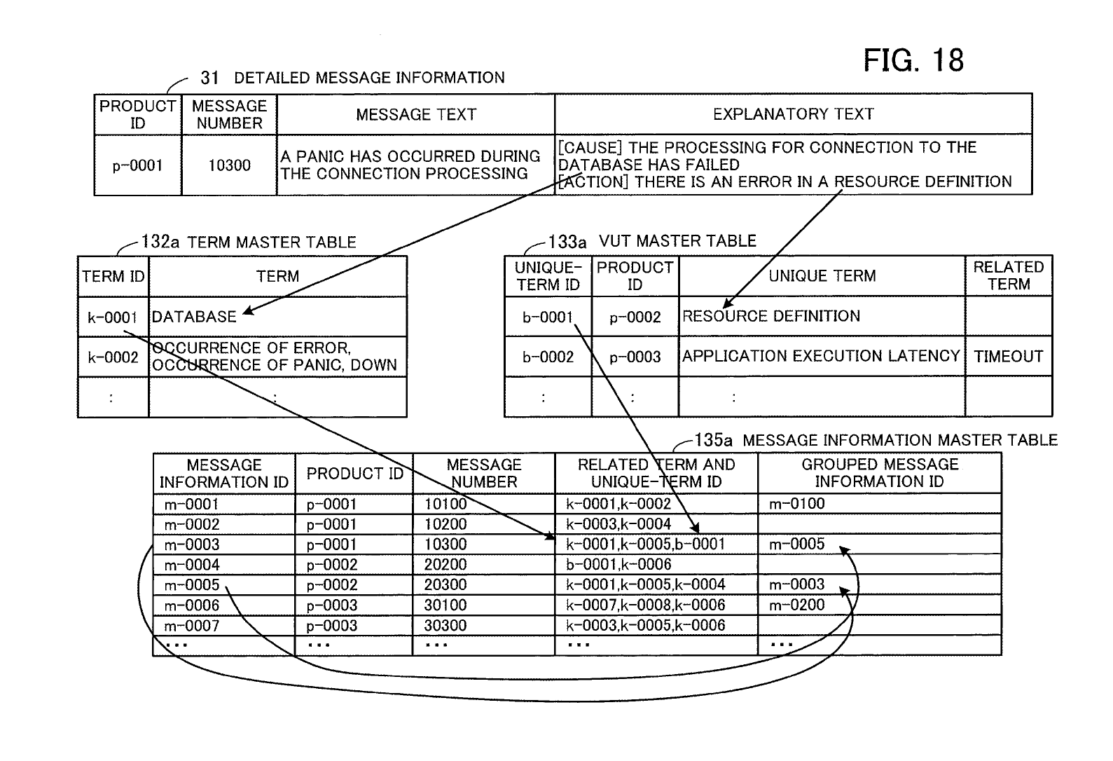

FIG. 18 illustrates an example of how the message information master table 135a is created. For example, message information having a message information ID “m-0003” is registered in the message information master table 135a. This message information corresponds to a message having a message number “10300” that is output from an application having a product ID “p-0001”. Detailed message information 31 corresponding to this message includes an explanatory text indicating that: “[cause] the processing for connection to the database has failed; [action] there is an error in a resource definition.” The term “database” included in the explanatory text is registered in the term master table 132a. Accordingly, the term ID of the term is registered in the corresponding box under the column RELATED TERM AND UNIQUE-TERM ID. In addition, the character string “resource definition” included in the explanatory text is registered in the VUT master table 133a. Accordingly, the unique-term ID of the vendor-unique term is also registered in the corresponding box under the column RELATED TERM AND UNIQUE-TERM ID.

In the example in FIG. 18, it is assumed that the message association unit 134 groups messages having at least two terms or vendor-unique terms in common. For example, the box under RELATED TERM AND UNIQUE-TERM ID corresponding to the message information having the message information ID “m-0003” includes “k-0001, k-0005, and b-0001,” and the box under RELATED TERM AND UNIQUE-TERM ID corresponding to the message information having the message information ID “m-0005” includes “k-0001, k-0005, and k-0004.” The two entries of message information have two terms or vendor-unique terms, namely, “k-0001 and k-0005” in common. Accordingly, the message information having the message information ID “m-0003” includes the message information ID “m-0005” as a corresponding grouped message information ID. Likewise, the message information having the message information ID “m-0005” includes the message information ID “m-0003” as a corresponding grouped message information ID.

In this way, the messages that belong to the same group are associated with each other in the message information master table 135a.

After the above preliminary processing is performed, when a malfunction or the like occurs in a system, in accordance with instructions from the operator, the information processing apparatus 100 performs message log analysis processing in order to analyze the cause of the malfunction.

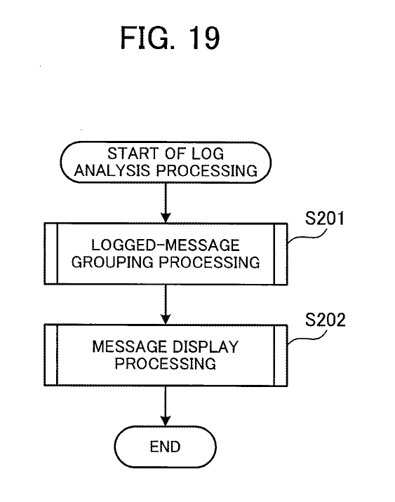

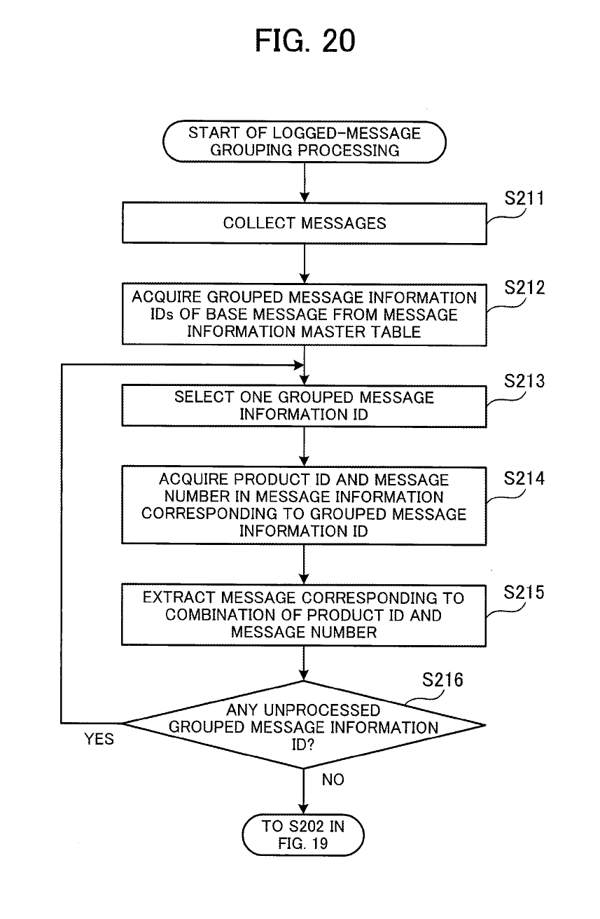

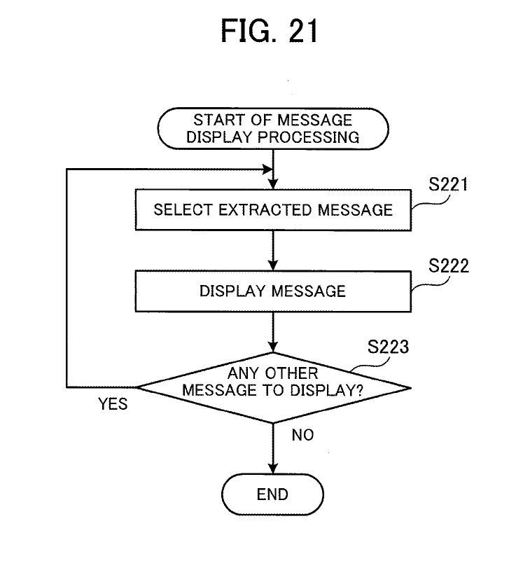

FIG. 19 is a flowchart illustrating an exemplary procedure for the log analysis processing.

[Step S201] The log analysis unit 136 performs logged-message grouping processing. For example, the log analysis unit 136 collects messages from the log storage units 121 to 123 and extracts messages that belong to the same group as the group to which a message selected by the operator belongs. The logged-message grouping processing will be described in detail below with reference to FIG. 20.

[Step S202] The log analysis unit 136 displays the message selected by the operator and the other message that belongs to the same group as the group to which the selected message belongs on the monitor 21. This processing will be described in detail below with reference to FIG. 21.

Next, the logged-message grouping processing will be described in detail.

FIG. 20 is a flowchart illustrating an exemplary procedure for the logged-message grouping processing.

[Step S211] The log analysis unit 136 collects messages from the log storage units 121 to 123. The log analysis unit 136 may collect only the messages output in a predetermined period of time. For example, if the log analysis unit 136 can detect the malfunction occurrence time, the log analysis unit 136 may only collect those messages each provided with a time stamp that indicates time before or after the malfunction occurrence time within a predetermined time range. The log analysis unit 136 adds a product ID of the application that has output the message to the collected message and stores the message in a memory.

[Step S212] The log analysis unit 136 acquires grouped message information IDs of a base message from the message information master table 135a. For example, from the operator, the log analysis unit 136 receives an operation input that specifies a base message from among the collected messages. Next, the log analysis unit 136 searches the message information master table 135a for a message information ID of the base message by using the message number of the specified base message and the product ID of the application that has output the base message as the keys. Next, the log analysis unit 136 acquires all the message information IDs (grouped message information IDs) registered in the box under the column GROUPED MESSAGE INFORMATION ID corresponding to the message information ID hit by the search.

[Step S213] The log analysis unit 136 selects one grouped message information ID that has not been processed yet from the grouped message information IDs acquired in step S212.

[Step S214] The log analysis unit 136 acquires the product ID and the message number included in the message information corresponding to the acquired grouped message information ID. For example, the log analysis unit 136 searches the boxes under the column MESSAGE INFORMATION ID in the message information master table 135a by using the acquired grouped message information ID as a key. Consequently, the log analysis unit 136 acquires the product ID and the message number corresponding to the message information ID hit by the search from the message information master table 135a.

[Step S215] The log analysis unit 136 searches the messages collected in step S211 for a message including a combination of the product ID and the message number acquired in step S214. Next, the log analysis unit 136 extracts the message hit by the search.

[Step S216] The log analysis unit 136 determines whether there is any unprocessed grouped message information ID in the grouped message information IDs acquired in step S212. If there is such grouped message information ID, the processing returns to step S213. If all the grouped message information IDs have been processed, the log analysis unit 136 ends the logged-message grouping processing.

Next, the message display processing will be described in detail.

FIG. 21 is a flowchart illustrating an exemplary procedure for the message display processing.

[Step S221] From the messages extracted by the message extraction processing, the log analysis unit 136 selects a message that has not been displayed yet.

[Step S222] The log analysis unit 136 associates the selected message with the base message and displays the associated messages on the monitor 21.

[Step S223] The log analysis unit 136 determines whether all the messages extracted by the message extraction processing has been displayed. If there is a message that has not been selected yet, the processing returns to step S221. Otherwise, the log analysis unit 136 ends the message display processing.

In this way, messages that are related to each other are displayed together.

As described above, according to the second embodiment, the information processing apparatus 100 groups messages by using explanatory texts for message texts. As a result, the accuracy of the grouping processing is improved. A message text often represents only a simplified content of the message. Namely, if the information processing apparatus 100 compares only message texts with each other, it is highly likely that the information processing apparatus 100 inaccurately determines whether messages are related to each other. In contrast, an explanatory text represents the content of the message in detail. Thus, by comparing explanatory texts, the information processing apparatus 100 can determine whether messages are related to each other more accurately.

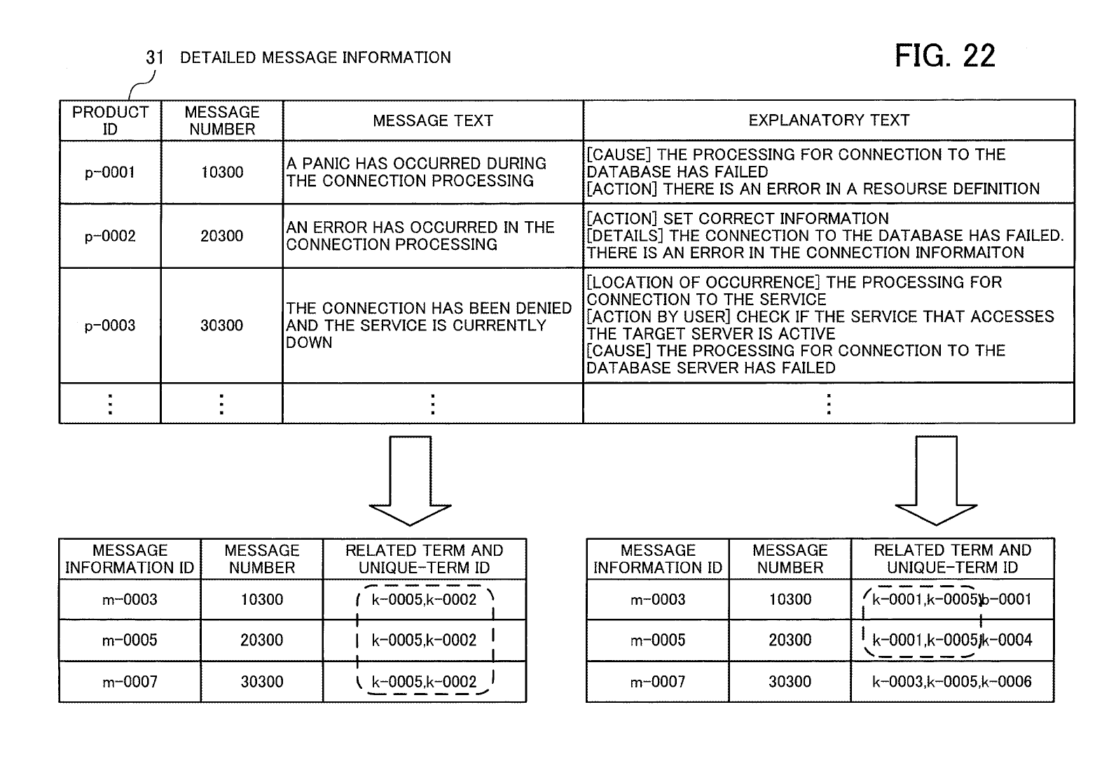

FIG. 22 illustrates the difference between grouping processing by using message texts and grouping processing by using explanatory texts. In the example in FIG. 22, the top two messages illustrated in the detailed message information 31 are messages output when an abnormal condition is detected in processing for connection to a database. The third message from the top is a message output when an abnormal condition in a service that connects to a database is detected.

In this example, the top two messages share the same cause; namely, the messages are related to each other. Therefore, it is appropriate to group the top two messages into the same group. In contrast, the third message from the top has a different cause from that of the other two messages. Namely, since the message is not probably related to the other two messages, it is inappropriate to group the third message into the same group as that of the other two messages.

The following description will be made assuming that the information processing apparatus 100 determines that “connection processing” and “connection” are synonyms (term ID k-0005) and that “panic,” “error,” and “down” are synonyms (term ID k-0002). It is also assumed that the information processing apparatus 100 determines that “database” (term ID k-0001) and “database server” are not synonyms. In addition, it is also assumed that the information processing apparatus groups messages having at least two terms or vendor-unique terms in common into the same group.

In such case, if the information processing apparatus 100 groups messages by using only message texts, the information processing apparatus 100 determines that all the message texts for the respective three messages include a term having the term ID “k-0002” and a term having the term ID “k-0005”. Consequently, the information processing apparatus 100 groups all the three messages into the same group. As a result, an inaccurate result is obtained.

If the information processing apparatus 100 uses only the explanatory texts for grouping, the information processing apparatus 100 determines that both the explanatory texts for the top two messages include a term having the term ID “k-0001” and a term having the term ID “K-0005.” However, the information processing apparatus 100 determines that the explanatory text for the third message does not include a term having the term ID “k-0001.” Consequently, while the information processing apparatus 100 groups the top two messages into the same group, the information processing apparatus 100 does not include the third message into the same group with the other two messages. As a result, an accurate result is obtained.

In this way, by using the explanatory texts, the information processing apparatus 100 performs accurate grouping. By using both the message texts and explanatory texts, the information processing apparatus 100 also performs accurate grouping. In the case illustrated in FIG. 22, for example, if the information processing apparatus 100 uses both the message texts and the explanatory texts for grouping, the information processing apparatus 100 groups messages having at least three terms or vendor-unique terms in common into the same group. In this way, the information processing apparatus 100 can perform accurate grouping.

In addition, according to the second embodiment, since the information processing apparatus 100 extracts vendor-unique terms and uses the extracted vendor-unique terms for grouping messages, the information processing apparatus 100 can determine whether messages are related to each other more accurately. Namely, the use of vendor-unique terms prevents erroneous association between messages that are not related to each other. In addition, the use of vendor-unique terms prevents omission of association between the related messages.

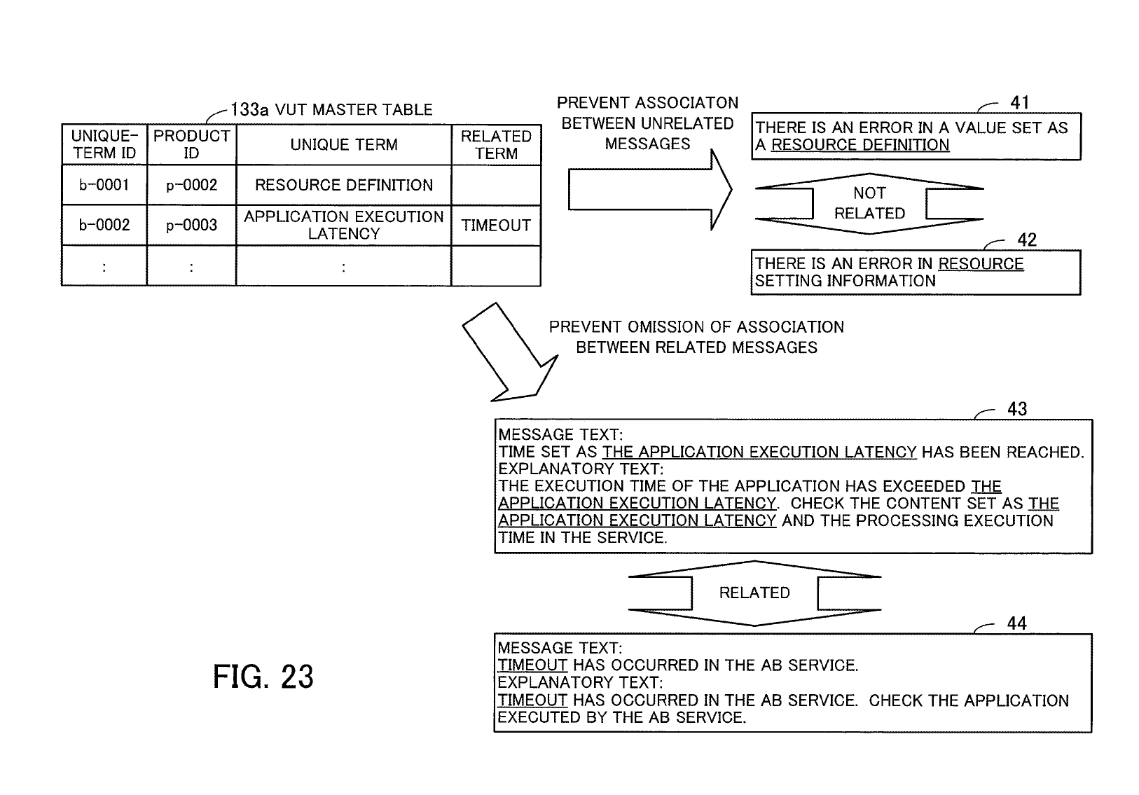

FIG. 23 illustrates an example that indicates how accuracy in determining related messages is improved by using vendor-unique terms. There are terms that are normally considered to be synonyms. However, there are cases in which the information processing apparatus 100 determines that such terms are not synonyms by using the vendor-unique terms, so as to perform accurate association of messages. The following example will be described assuming that there are a message 41 that includes a sentence “there is an error in a value set as a resource definition” in the corresponding explanatory text and a message 42 that includes a sentence “there is an error in resource setting information” in the corresponding explanatory text. The term “resource definition” is a vendor-unique term. The term “resource” included in the vendor-unique term “resource definition” in the message 41 and the term “resource” in the message 42 are normally considered to be synonyms. However, in the example in FIG. 23, since “resource definition” is a vendor-unique term, the information processing apparatus 100 recognizes that the term “resource definition” has a unique meaning defined by the corresponding vendor. Therefore, the information processing apparatus 100 does not use the term “resource” by itself to determine the semantic similarity. Thus, the information processing apparatus 100 determines that these two messages 41 and 42 are not related to each other. As described above, if a term is uniquely defined by an application vendor, the information processing apparatus 100 does not perform association on the basis of a common meaning of the term. Namely, erroneous association between messages that are not related to each other is prevented.

There are terms that are not normally considered to be synonyms. However, there are cases in which the information processing apparatus 100 determines that such terms are synonyms by using the vendor-unique terms, so as to perform accurate association of messages. The following example will be described assuming that there are messages 43 and 44 that include the following respective message texts and explanatory texts.

The message 43 includes the message text “time set as application execution latency has been reached” and the explanatory text “the execution time of the application has exceeded the application execution latency; check the content set as the application execution latency and the processing execution time in the service.”

The message 44 includes the message text “Timeout has occurred in the AB service” and the explanatory text “Timeout has occurred in the AB service; check the application executed by the AB service.”

Normally, “application execution latency” and “timeout” are not considered as synonyms. Therefore, if the information processing apparatus 100 does not use vendor-unique terms, the information processing apparatus 100 does not group the first and second messages into the same group. However, as illustrated in FIG. 23, if the term “application execution latency” is registered as a vendor-unique term and if the term “timeout” is registered as a related term that relates to “application execution latency,” the information processing apparatus 100 determines the term “application execution latency” and the term “timeout” to be synonymous. Consequently, the information processing apparatus 100 determines that contents indicated by the two messages 43 and 44 have semantic similarity and that the messages 43 and 44 are related to each other. Thus, the information processing apparatus 100 groups the messages 43 and 44 into the same group. By using the vendor-unique terms in this way, the information processing apparatus 100 associates a message that includes a phrase whose meaning is uniquely defined by the corresponding application vendor with a message that includes a common term having a similar meaning to the phrase. As a result, omission of association between related messages is prevented.

According to one aspect, related messages are grouped more accurately.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a message grouping program that causes a computer to execute a process comprising:
acquiring a plurality of messages that are output from a plurality of output source apparatuses, respectively;
acquiring a plurality of explanatory texts from a plurality of documents, the plurality of explanatory texts respectively relating to the plurality of messages, the plurality of documents respectively relating to the plurality of output source apparatuses; and
generating a plurality of message groups that include related messages respectively, based on the plurality of explanatory texts for the respective messages.

2. The non-transitory computer-readable recording medium according to claim 1, wherein the generating a plurality of message groups includes:
determining, based on semantic similarity among terms included in the plurality of explanatory texts for the respective messages, whether messages are related to each other; and
grouping messages that are determined to be related to each other into a same group.

3. The non-transitory computer-readable recording medium according to claim 1, wherein the generating a plurality of message groups includes:
determining based on a first document, from which a first explanatory text for a first message is acquired, whether the first document includes a unique term that is semantically unique to the first document and comprehends a meaning of the unique term;
determining, based on the meaning of the unique term included in the first explanatory text, whether the first message and a second message are related to each other; and
grouping the first and second messages into a same group when the first and second messages are determined to be related to each other.

4. The non-transitory computer-readable recording medium according to claim 3, wherein the generating a plurality of message groups includes:
referring to the first document and determining a term that appears in the first document and that does not appear in the second document to be a unique term in the first document;
extracting a related term from information relating to the unique term in the first document; and
determining, based on semantic similarity between the related term of the unique term included in the first explanatory text and a term included in a second explanatory text for the second message, whether the first and second messages are related to each other.

5. The non-transitory computer-readable recording medium according to claim 1, wherein:
the process further includes, before acquiring the plurality of messages,
acquiring information about a plurality of messages that could be output from the output source apparatuses, from a plurality of documents relating to the respective output source apparatuses,
acquiring a plurality of explanatory texts for the respective messages that could be output, based on the plurality of documents relating to the respective output source apparatuses, and
registering message numbers of messages that are related to each other, in association with each other, based on the plurality of explanatory texts for the respective messages that could be output; and
the generating a plurality of message groups includes, after acquiring the plurality of messages, grouping, among the plurality of messages, the messages whose message numbers are associated with each other into the same group.

6. A grouping apparatus comprising:
a memory configured to store documents respectively relating to a plurality of output source apparatuses; and
a processor configured to execute a process including:
acquiring a plurality of messages that are output from output source apparatuses, respectively;
acquiring a plurality of explanatory texts from a plurality of documents, the plurality of explanatory texts respectively relating to the plurality of messages, the plurality of documents respectively relating to the output source apparatuses; and
generating a plurality of message groups that include related messages respectively, based on the plurality of explanatory texts for the respective messages.

7. A grouping method comprising:
acquiring, by a processor, a plurality of messages that are output from a plurality of output source apparatuses, respectively;
acquiring, by the processor, a plurality of explanatory texts from a plurality of documents, the plurality of explanatory texts respectively relating to the plurality of messages, the plurality of documents respectively relating to the plurality of output source apparatuses; and
generating, by the processor, a plurality of message groups that include related messages respectively, based on the plurality of explanatory texts for the respective messages.
